(19) United States
(12) Patent Application Publication
(10) Pub. No.: US 2005/0092141 A1
(43) Pub. Date: May 5, 2005

(54) Screw bit connector

(76) Inventor: Yao-Lin Cho, Da-An Township (TW)

Correspondence Address: Mr. Phillip LIU, 6980, Whiteoak Dr., Richmond, BC, V7E 4Z9, CA

(21) Appl. No.: 10/699,875

(22) Filed: Nov. 4, 2003

(51) Int. Cl. B25B 23/00

(52) U.S. Cl. 81/438

(57) ABSTRACT

A screw bit connector includes a body having a section of polygonal periphery and a section of circular periphery. An extension having a polygonal recess extends from an end of the section of polygonal periphery and a polygonal engaging stud extends from an end of the section of circular periphery. A screw bit can be inserted in the polygonal recess and the engaging stud can be connected to a ratchet tool. The polygonal recess can be connected to a driving handle and the polygonal engaging stud can be connected with a socket which is used to drive a nut or a screw head.

### FIELD OF THE INVENTION

The present invention relates to a screw bit connector which can be cooperated with a wrench and/or a driving handle to drive a screw or a nut.

### BACKGROUND OF THE INVENTION

A conventional screw connector generally includes a tubular body having an end for being engaged with a screw bit and the other end of the body has a recess such that a driving handle is connected to the body by inserting a polygonal end of the driving handle with the recess. The driving handle increases the total length of the combination such that the user does not need to hold the tubular body to rotate the screw bit. Nevertheless, because the tubular body and the driving handle share a common axis so that only a short arm of force can be used to rotate the screw bit and this is not an efficient way to operate.

The present invention intends to provide a screw bit connector that includes a polygonal pouter periphery for being cooperated with a wrench, a recess is defined in one end of the connector so as to be connected a screw bit, and an engaging port extends from the other end of the connector such that a socket is engaged with the engaging port.

### SUMMARY OF THE INVENTION

The present invention relates to a screw bit connector which comprises a body having a section of polygonal periphery and a section of circular periphery. An extension extends from an end of the section of polygonal periphery and has a polygonal recess defined in an end thereof. A passage is defined radially through a wall of the extension and is in communication with the polygonal recess so as to receive a bead therein. A polygonal engaging port extends from an end of the section of circular periphery so as to be connected with a ratchet tool or a socket.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the screw bit connector and a collar of the present invention;

FIG. 2 is a perspective view to show c

FIG. 3 is a cross sectional view to show the screw bit connector of the present invention;

FIG. 4 shows the connector is driven by a driving handle at the engaging port and a screw bit is engaged with the polygonal recess to drive a screw;

FIG. 5-1 shows that an open end of a wrench is clamped to the section of polygonal periphery of the connector;

FIG. 5-2 shows that a closed end of a wrench is clamped to the section of polygonal periphery of the connector;

FIG. 6 shows that an open end of a wrench is clamped to the section of polygonal periphery of the connector and a driving handle is connected to the engaging port of the connector;

FIG. 7 shows the connector is connected between a socket and a driving handle to drive a bolt head, and

FIG. 8 shows the connector is connected to a socket to drive a bolt head by using a wrench.

### DETAILED DESCRIPTION OF THE PREFERRED EMBODIMENT

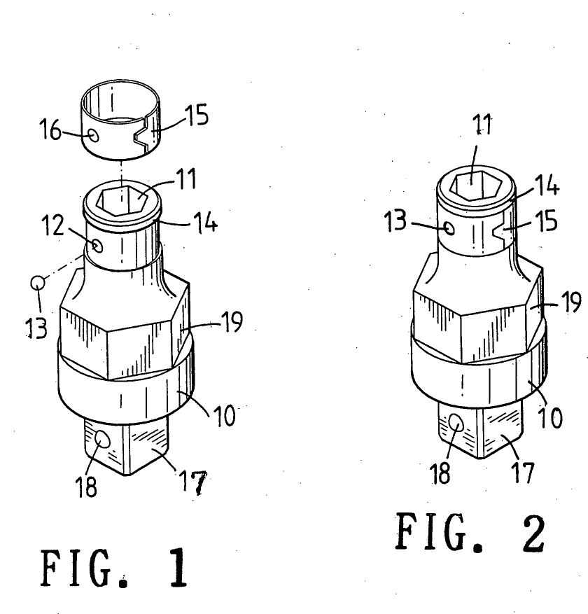

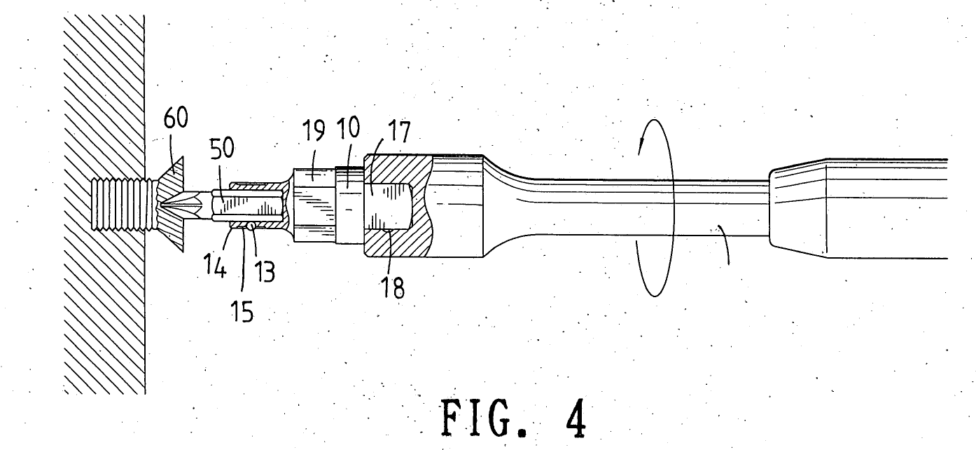

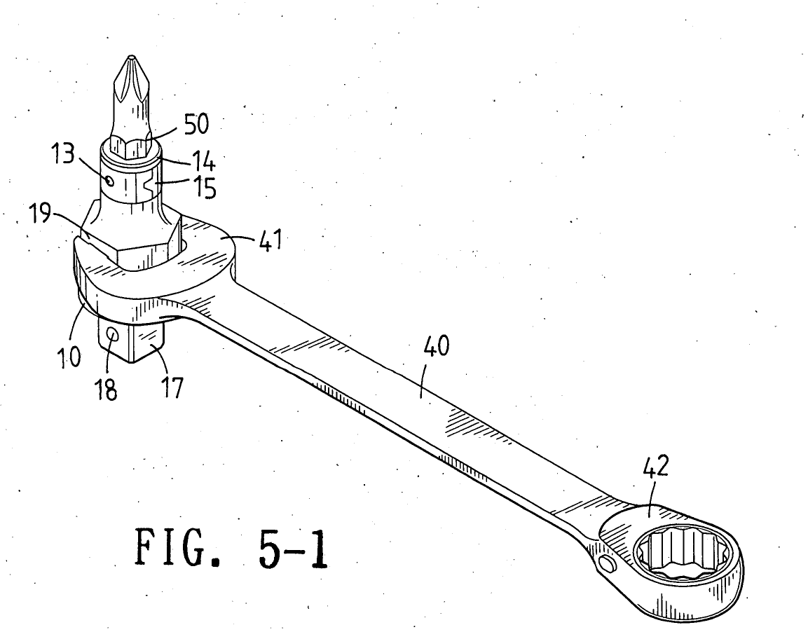

Referring to FIGS. 1 to 3, the screw bit connector of the present invention comprises a body having a section of polygonal periphery 19 and a section of circular periphery 10. An extension extends from an end of the section of polygonal periphery 19 and a polygonal recess 11 is defined in an end of the extension so as to receive a screw bit 50 as shown in FIG. 4. A passage 13 is defined radially through a wall of the extension and is in communication with the polygonal recess 11. A bead 13 is received in the passage 11 so as to securely position the screw bit 50 in the polygonal recess 11. A flange 14 extends radially from a periphery of the extension and a collar 15 is mounted to the extension and is stopped by the flange 14. A hole 16 is defined through the collar 15 and sizes to limit the bead 13 from dropping from the passage 13. A polygonal engaging port 17 extends from an end of the section of circular periphery 10. The polygonal engaging port 17 has a boss 18 extending from one of sides thereof.

As disclosed in FIG. 4, when driving a screw 60, the screw bit 50 is engaged with the polygonal recess 11 and a driving handle 20 that has a recess is connected to the polygonal engaging port 17 by receiving the polygonal port 17 in the recess of the driving handle 20. The user simply rotates the driving handle 20 to drive the screw 60.

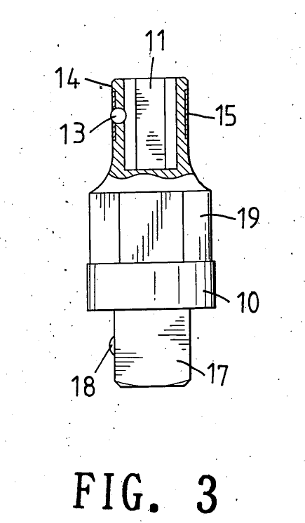

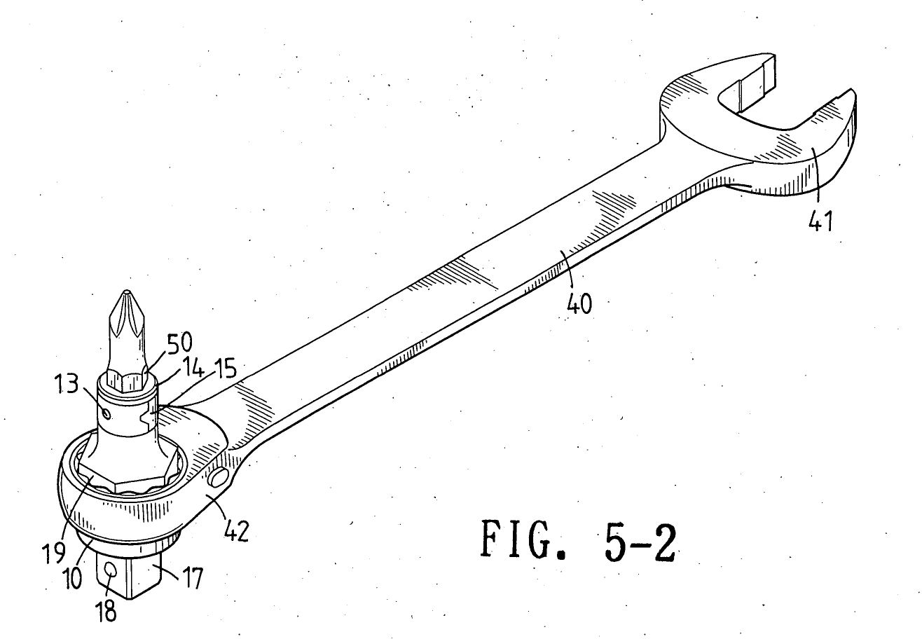

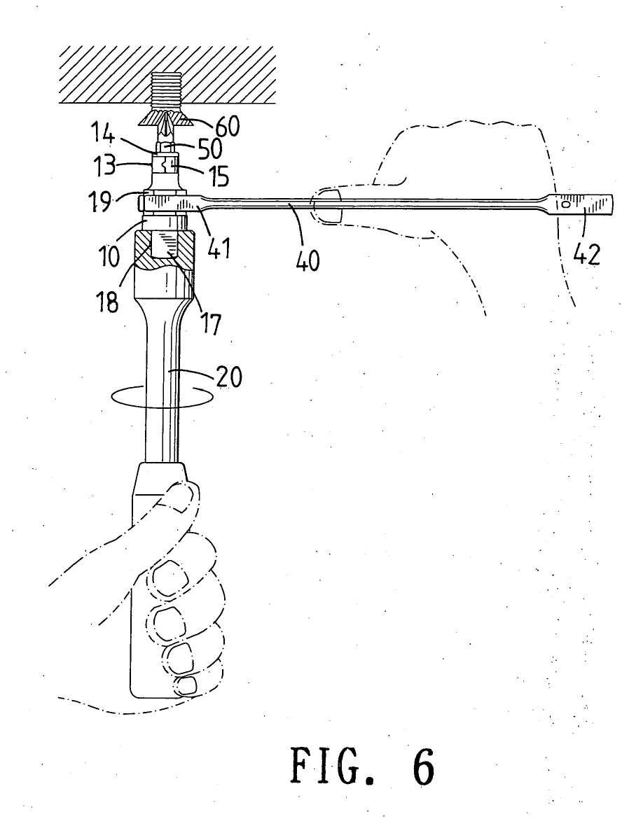

If the space is large enough, as shown in FIG. 5-1, an open end 41 of a wrench 0 is clamped to the section of polygonal periphery 19 of the connector so as to rotate the connector efficiently. FIG. 5-2 shows that a closed end 42 of the wrench 40 is clamped to the section of polygonal periphery 19 of the connector. The user may also use both of the wrench 40 and the driving handle 20 to rotate the connector.

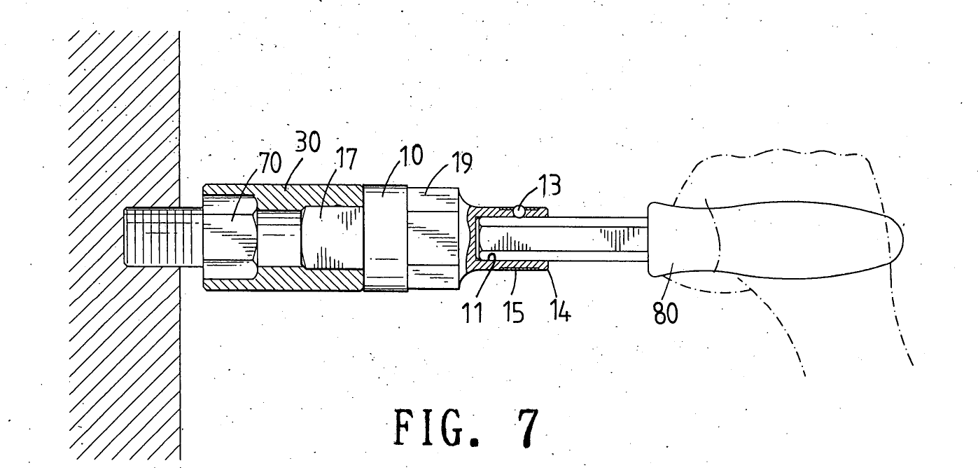

When driving a bolt head 70, as shown in FIG. 7, the connector is connected between a socket 30 and a driving handle 80. The socket 30 has one end thereof mounted to the bolt head 70 and is securely position by the boss 18 on the engaging port 17, and the other end of the socket 30 is connected to the polygonal engaging port 17. The driving handle 80 is engaged with the polygonal recess 11 so that when rotating the driving handle 80, the bolt head 70 is rotated with the rotation of the socket 30.

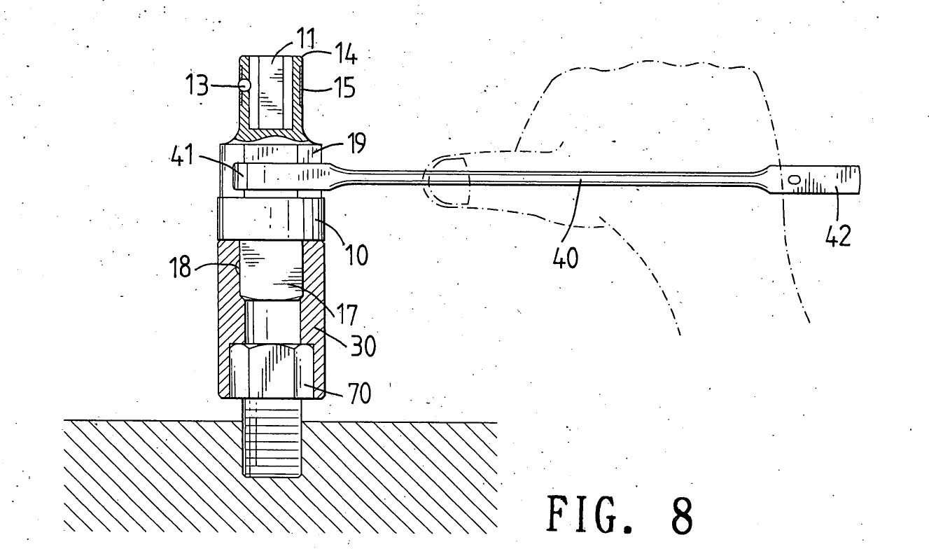

FIG. 8 shows that the connector connected to the socket 30 mounted to the bolt head 70 can be rotated by using the open end of the wrench 40.

While we have shown and described the embodiment in accordance with the present invention, it should be clear to those skilled in the art that further embodiments may be made without departing from the scope of the present invention.

1. A screw bit connector comprising:
a body having a section of polygonal periphery and a section of circular periphery, an extension extending from an end of the section of polygonal periphery and a polygonal recess defined in an end of the extension, a circular diameter of the extension being smaller than a diagonal width of the section of polygonal periphery, a passage defined radially through a wall of the extension and being in communication with the polygonal recess, a bead received in the passage, a polygonal engaging stud extending from an end of the section of circular periphery.

2. The connector as claimed in claim 1, wherein a flange extends radially from a periphery of the extension and a collar mounted to the extension and is stopped by the flange, a hole defined through the collar and limiting the bead from dropping from the passage.

3. The connector as claimed in claim 1, wherein the polygonal engaging stud has a boss extending from one of sides thereof.
